(19) United States
(12) Patent Application Publication
(10) Pub. No.: US 2026/0328027 A1
(43) Pub. Date: Oct. 22, 2026

(54) VEHICLE DOOR LATCHING DEVICE

(71) Applicant: U-Shin Ltd., Nagano (JP)

(72) Inventors: Takashi Uda, Hiroshima (JP); Mikio Yamagata, Hiroshima (JP); Nobuya Akagi, Hiroshima (JP)

(21) Appl. No.: 19/567,504

(22) Filed: Mar. 16, 2026

(30) Foreign Application Priority Data
Apr. 22, 2025 (JP) 2025-070781
Mar. 13, 2026 (JP) 2026-040731

(51) Int. Cl. E05B 81/54; E05B 85/02

(52) U.S. Cl. CPC E05B 81/54; E05B 85/02

(57) ABSTRACT

The conductive plate of the door latching device includes a first terminal connected to the lock position detection switch at one end of the conductive plate body and a second terminal connectable to the external connector at the other end of the conductive plate body. The second terminal is fitted into a fitting groove defined between the pair of groove side walls protruding from the inner surface of the casing. The terminal base of the second terminal has a pair of side edges separated from each other in the width direction and extending in the terminal protruding direction. The second terminal has a fin that protrudes in the width direction from the side edge and comes into pressure contact with the groove side walls in the fitting groove.

### CROSS-REFERENCE TO RELATED APPLICATIONS

This application claims benefit of priority to Japanese Patent Application No. 2025-070781 filed on Apr. 22, 2025, and Japanese Patent Application No. 2026-040731 filed on Mar. 13, 2026, the entire content of which is incorporated herein by reference.

### BACKGROUND

### 1. Technical Field

The present invention relates to a vehicle door latching device.

### 2. Background Art

JP 2006-264641 A discloses a housing including a switch that detects a state of a vehicle door latching mechanism. The switch is connected to one end of the conductive member, and the other end of the conductive member constitutes a terminal of the connector. The detection signal generated by the switch is output to an external control device via the conductive member and the connector.

### SUMMARY

When the switch is assembled to the conductive member, a load is applied to one end of the conductive member. As a result, there is a possibility that the other end of the conductive member floats and the terminal is displaced in position.

An object of the present invention is to provide a door latching device capable of suppressing positional deviation of a terminal.

According to one aspect of the present invention, there is provided a vehicle door latching device including: a casing attached to a vehicle; a latch mechanism provided in the casing and configured to switch between a latched state in which a door of the vehicle is held in a closed state and an unlatched state in which opening of the door is allowed; a lock mechanism configured to be displaced between an unlock position in which switching of the latch mechanism to the unlatched state is allowed and a lock position in which switching to the unlatched state is disabled; an electric component associated with an operation of the latch mechanism or the lock mechanism; a conductive plate housed in the casing, the conductive plate including a conductive plate body extending along an inner surface of the casing, a first terminal provided at one end portion of the conductive plate body, the first terminal protruding in a terminal protruding direction perpendicular to an extending direction of the conductive plate body and being connected to the electric component, and a second terminal provided at the other end portion of the conductive plate body, the second terminal protruding in the terminal protruding direction and connectable to an external component provided in the vehicle; and a terminal support portion including a pair of groove side walls protruding from the inner surface of the casing and facing each other in a width direction, the terminal support portion defining a fitting groove in which the first terminal or the second terminal is fitted between the pair of groove side walls, in which a fitted terminal of the first terminal and the second terminal to be fitted into the fitting groove includes a terminal base including a pair of side edges separated from each other in the width direction and extending in the terminal protruding direction, and a fin protruding from the side edge in the width direction and coming into pressure contact with the groove side wall in the fitting groove.

According to the above configuration, when the electric component or the external component is assembled to the conductive plate, even if a load is applied to the conductive plate, displacement of the fitted terminal can be suppressed by friction between the fin and the groove side wall.

According to the present invention, it is possible to provide a door latching device capable of suppressing positional deviation of a terminal.

### BRIEF DESCRIPTION OF DRAWINGS

FIG. 1 is a perspective view of a door latching device according to an embodiment;

FIG. 2 is an exploded perspective view of the door latching device;

FIG. 3 is a block diagram of the door latching device;

FIG. 4 is a perspective cross-sectional view of a connector;

FIG. 5 is a plan view of a lower case in a state in which a conductive plate and an electric component are assembled;

FIG. 6 is a perspective view of the conductive plate;

FIG. 7 is a perspective view of the lower case;

FIG. 8 is a perspective view of the lower case illustrating a state in which the conductive plate is assembled;

FIG. 9 is a plan view of the lower case in a state in which the conductive plate and the switch are assembled;

FIG. 10 is a perspective view of a terminal having fins;

FIG. 11 is a front view of a terminal having the fin;

FIG. 12 is a plan view of a terminal having the fin;

FIG. 13 is an exploded front view of a terminal support portion and a terminal having fins;

FIG. 14 is a plan view of the terminal support portion shown in a state in which the terminal is fitted; and

FIG. 15 is a cross-sectional view of the terminal support portion illustrating a state in which the fin is in pressure contact with a groove side wall in a fitting groove.

### DETAILED DESCRIPTION

Hereinafter, embodiments will be described with reference to the drawings. Note that the same or corresponding elements are denoted by the same reference numerals throughout the drawings, and overlapping of detailed description will be omitted.

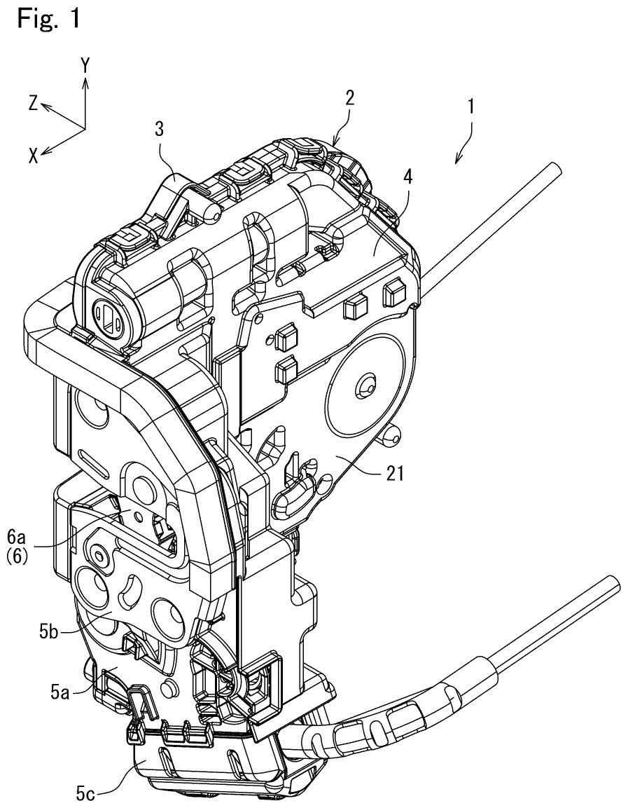

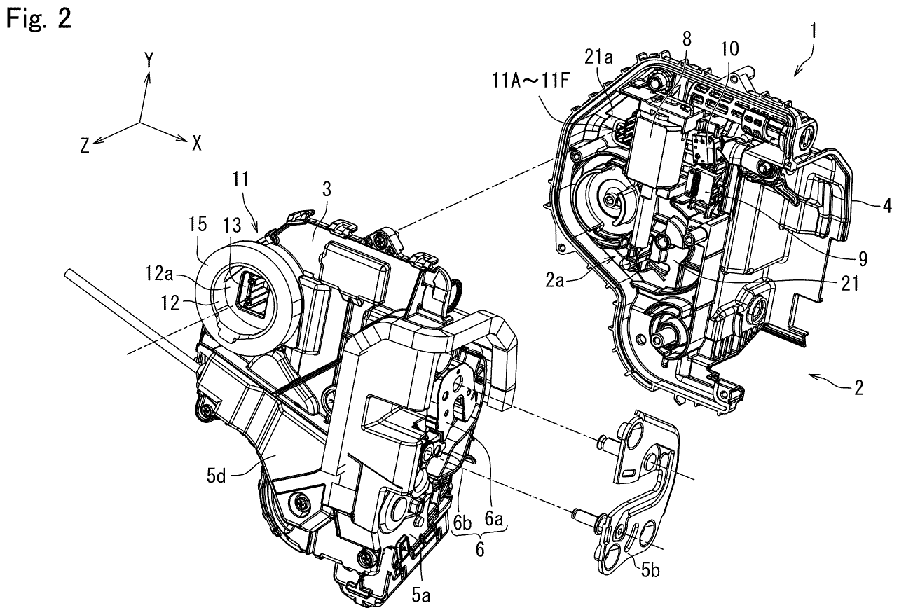

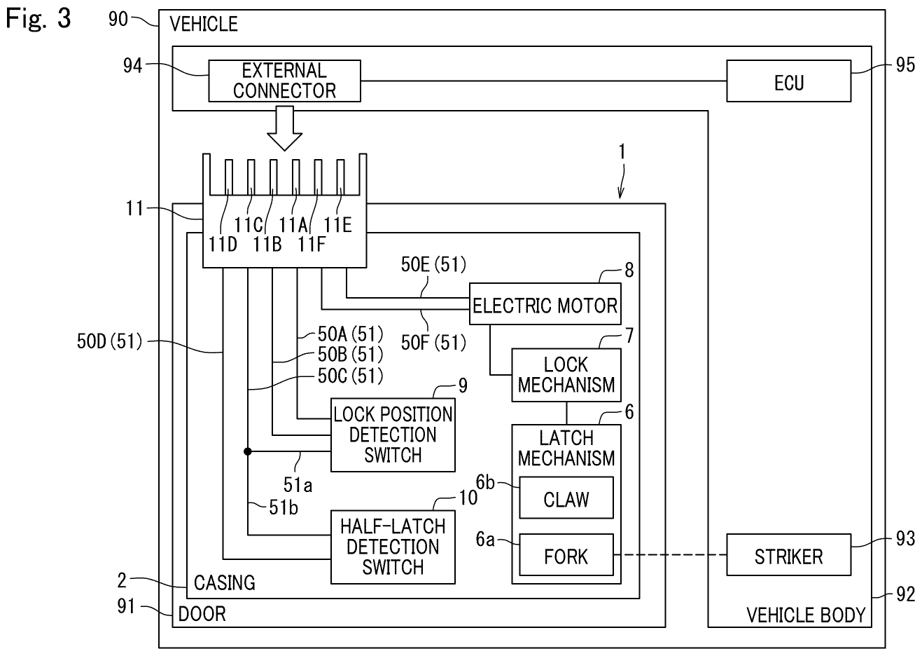

Referring to FIGS. 1 and 2, a door latching device 1 for a vehicle according to the present embodiment includes a casing 2 attached to a door 91 (see FIG. 3) of a vehicle 90. The casing 2 is configured by assembling a plurality of casing components to each other, and defines an internal space 2a that houses at least some of the components of the door latching device 1. The casing component mainly includes an upper case 3 and a lower case 4. The upper case 3 and the lower case 4 are partially covered with a fence block 5a, a latch cover 5b, and cable covers 5c and 5d.

Referring to FIG. 3, the door latching device 1 includes a latch mechanism 6 and a lock mechanism 7. The latch mechanism 6 switches between a latched state in which the door 91 is locked to a vehicle body 92 and an unlatched state in which the locking of the door 91 to the vehicle body 92 is released. The lock mechanism 7 switches between an unlock position at which switching of the latch mechanism 6 to the unlatched state is allowed and a lock position at which switching of the latch mechanism 6 to the unlatched state is disabled, in response to operation of an unshown door handle disposed on the door.

The latch mechanism 6 has a fork 6a that releasably holds a striker 93 of the vehicle 90, and a claw 6b that detachably engages with the fork 6a. When the claw 6b is engaged with the fork 6a holding the striker 93, the fork 6a is held at the closed position, and the latch mechanism 6 enters the latched state. In the latched state, the door 91 is held in the closed state. When the claw 6b is detached from the fork 6a, the fork 6a can be displaced from the closed position. When the fork 6a is located at the release position, the latch mechanism 6 enters the unlatched state, and the opening operation of the door 91 is allowed.

The door latching device 1 includes an electric motor 8, a lock position detection switch 9, and a half-latch detection switch 10 as examples of electric components associated with the operation of the latch mechanism 6 or the lock mechanism 7 and housed in the casing 2.

The electric motor 8 generates a driving force for driving the lock mechanism 7. The lock mechanism 7 is electrically displaced. The lock position detection switch 9 outputs a detection signal indicating whether the lock mechanism 7 is located at the lock position or the unlock position. The half-latch detection switch 10 outputs a detection signal indicating whether or not the fork 6a is located at the closed position.

The electric motor 8, the lock position detection switch 9, and the half-latch detection switch 10 are connected to a connector 11. Connector terminals 11A to 11F of the connector 11 are configured by distal end portions of conductive plates 50A to 50F, and are integrated with the conductive plates 50A to 50F.

The connector 11 is configured to be mechanically and electrically connectable to an external connector 94 as an example of an external device provided in the vehicle 90. The external connector 94 is connected to an electronic control unit (ECU95) mounted on the vehicle 90. The lock position detection switch 9 is communicably connected to the ECU95 via the conductive plates 50A to 50C, the connector 11, and the external connector 94. The half-latch detection switch 10 is communicably connected to the ECU95 via the conductive plates 50C and 50D, the connector 11, and the external connector 94. The conductive plate 50C constitutes a ground line common to the two switches. An operation command signal output from the ECU95 is transmitted to the electric motor 8 via the external connector 94, the connector 11, and the conductive plates 50E and 50F, thereby operating the electric motor 8.

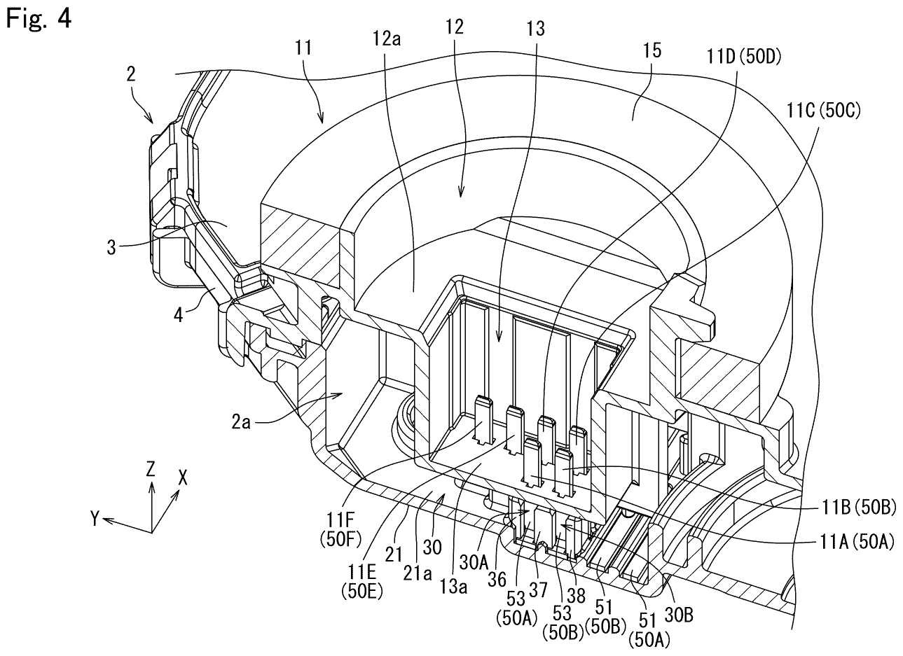

Referring to FIG. 4, the connector 11 is a female type and is open to the outer surface of the upper case 3. The connector 11 has a cylindrical first recess 12 provided on the outer surface of the upper case 3 and a second recess 13 further recessed from the central portion of an inner bottom surface 12a of the first recess 12. The first recess 12 is opened in a circular shape, and the second recess 13 is opened in a rectangular shape. The conductive plates 50A to 50F are housed in the internal space 2a and supported by a bottom wall 21 of the lower case 4. The connector terminals 11A to 11F pass through the through holes of the inner bottom surface 13a of the second recess 13, protrude from the internal space 2a to the second recess 13, and are aligned inside the second recess 13.

The external connector 94 indicated by a block in FIG. 3 is a male type although the illustration of the structure is omitted, and is configured to be insertable into the first recess 12 and the second recess 13. When the external connector 94 is attached to the connector 11, the connector terminals 11A to 11F are electrically connected to the terminals of the external connector 94, respectively. An annular waterproof pad 15 is provided around the first recess 12. The waterproof pad 15 is in close contact with the external connector 94 to prevent water from entering the first recess 12 and the second recess 13 from the outside of the casing 2.

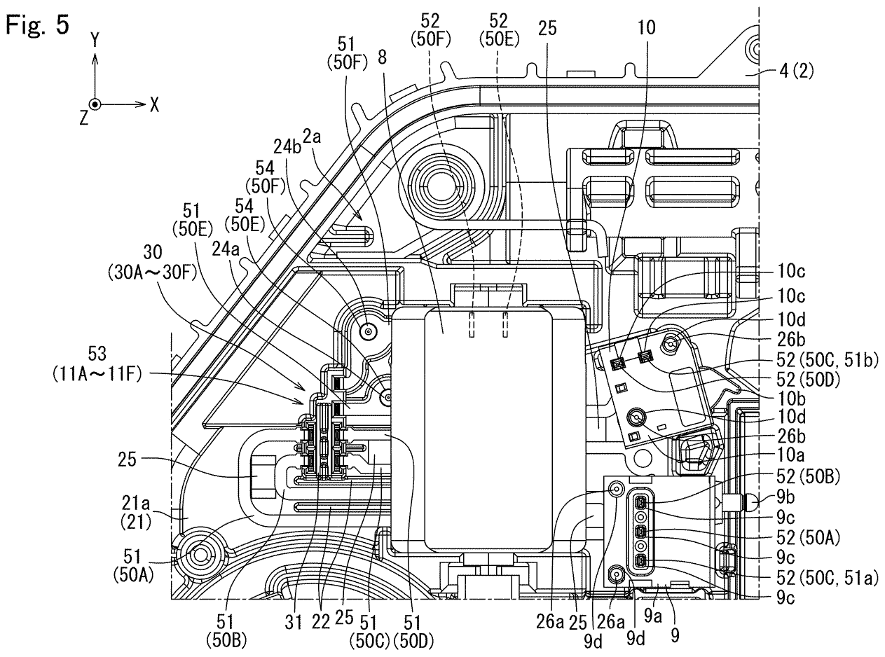

Hereinafter, structures of the conductive plates 50A to 50F and the bottom wall 21 of the lower case 4 will be described with reference to FIGS. 5 to 15. The inner surface 21a of the bottom wall 21 of the lower case 4 has a large number of irregularities for attachment of components of the door latching device 1 including the conductive plates 50A to 50F, but is basically flat. Hereinafter, for ease of explanation, the orthogonal direction of the inner surface 21a of the bottom wall 21 is defined as the vertical direction Z, and the upper case 3 (see FIG. 2) side is defined as an upper side.

FIG. 5 is a plan view of the inside of the lower case 4 as viewed from above, in which a direction orthogonal to the plane of FIG. 5 corresponds to the vertical direction Z, and an in-plane direction of FIG. 5 corresponds to the in-plane direction of the inner surface 21a of the bottom wall 21. The left-right direction in FIG. 5 is referred to as a first direction X, and the right side in FIG. 5 is referred to as one side thereof. The vertical direction in FIG. 5 is referred to as a second direction Y, and the upper side in FIG. 5 is referred to as one side thereof. The first direction X, the second direction Y, and the vertical direction Z are orthogonal to the other two directions.

The electric motor 8, the lock position detection switch 9, and the half-latch detection switch 10 are all disposed on one side in the first direction X with respect to the connector 11. The lock position detection switch 9 and the half-latch detection switch 10 are arranged in the second direction Y at substantially the same position in the first direction X. The half-latch detection switch 10 is disposed on one side in the second direction Y, and the lock position detection switch 9 is disposed on the other side. The electric motor 8 is disposed between the connector 11 and the lock position detection switch 9 and the half-latch detection switch 10 in the first direction X.

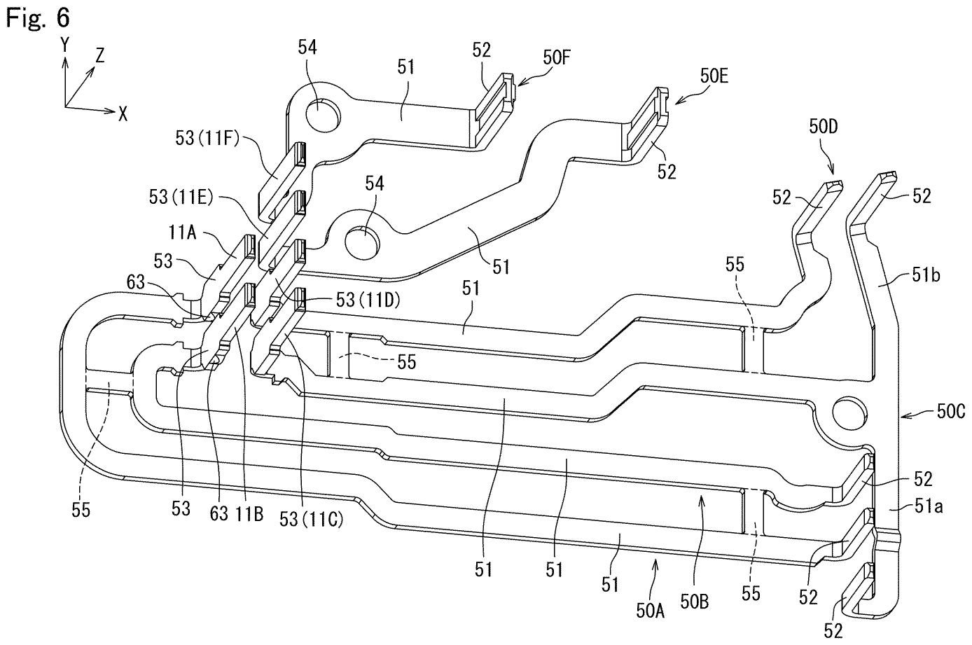

Referring to FIG. 6, each of the conductive plates 50A to 50F includes a conductive plate body 51, a first terminal 52, and a second terminal 53.

The conductive plate body 51 is formed of a conductive metal plate, and extends along the inner surface 21a of the bottom wall 21 of the lower case 4 as an example of the inner surface of the casing 2. The conductive plate body 51 is placed on the inner surface 21a and supported by the bottom wall 21 of the lower case 4. The lower case 4 is made of an insulating material.

The first terminal 52 is provided at one end portion of the conductive plate body 51 and protrudes in the terminal protruding direction. The second terminal 53 is provided at the other end portion of the conductive plate body 51 and protrudes in the terminal protruding direction. The terminal protruding direction is a direction perpendicular to the extending direction of the conductive plate body 51, and is along the vertical direction Z.

The first terminal 52 and the second terminal 53 are seamlessly continuous with the conductive plate body 51, and are provided integrally with the conductive plate body 51 by bending a metal blank. The first terminal 52 is connected to an electric component of the door latching device 1. The distal end portion of the second terminal 53 constitutes the connector terminals 11A to 11F, and can be connected to an external connector 94 (see FIG. 3) as an example of an external component provided in the vehicle 90.

Since the electric motor 8 is relatively close to the connector 11, the conductive plates 50E and 50F are relatively short. Conversely, the conductive plates 50A to 50D are relatively long. The conductive plate bodies 51 of the conductive plates 50A and 50B are connected to each other at both ends in the first direction X via temporary connection portions 55. The conductive plate bodies 51 of the conductive plates 50C and 50D are also connected to each other via temporary connection portions 55 at both ends in the first direction X. As described later, the temporary connection portion 55 is cut off in the process of assembling the conductive plates 50A to 50D to the casing 2. Accordingly, an assembling work of the door latching device 1 can be simplified. In the completed state of the door latching device 1, a short circuit between the conductive plates 50A and 50B and a short circuit between the conductive plates 50C and 50D do not occur.

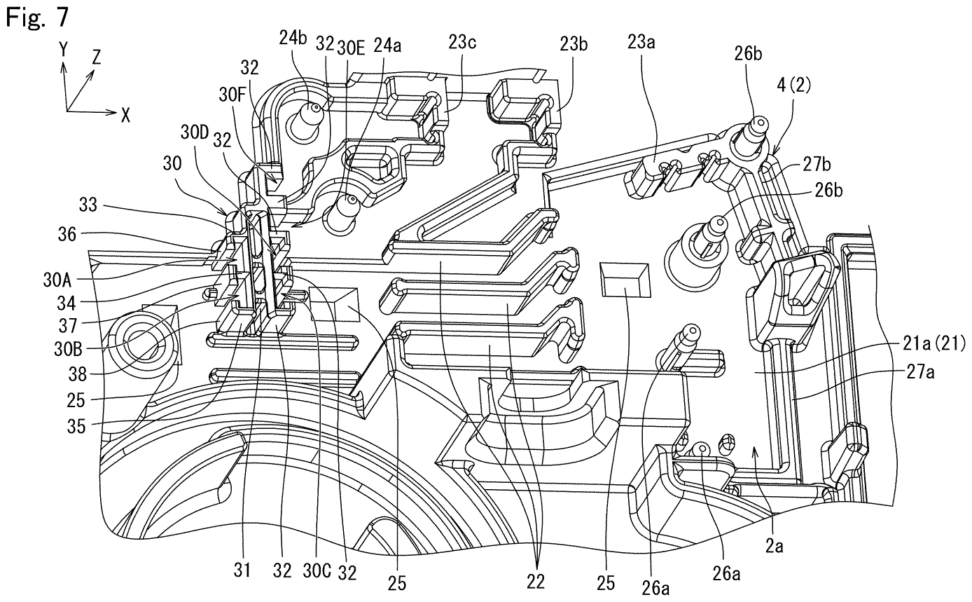

Referring to FIG. 7, the bottom wall 21 of the lower case 4 is provided with a plurality of guide ribs 22, terminal support portions 23a to 23c for the first terminal 52, and a terminal support portion 30 for the second terminal 53. The guide ribs 22 and the terminal support portions 23a to 23c and 30 protrude upward from the inner surface 21a.

The plurality of guide ribs 22 define, together with the inner surface 21a, a plurality of guide grooves each housing the conductive plate body 51. The conductive plate bodies 51 of the conductive plates 50A to 50F are disposed apart from each other by the guide ribs 22.

The terminal support portions 23a to 23c define fitting grooves extending in the vertical direction and opened upward. The terminal support portion 23a is provided with a pair of fitting grooves. One fitting groove is provided in each of the terminal support portions 23b and 23c. One fitting groove is fitted to one first terminal 52.

The terminal support portion 30 protrudes upward from the inner surface 21a and defines six fitting grooves 30A to 30F. The terminal support portion 30 includes a central wall 31, five groove side walls 32 located on one side in the first direction X with respect to the central wall 31, and groove side walls 33 to 35 located on the other side in the first direction X with respect to the central wall 31. The central wall 31 extends in the second direction Y.

The five groove side walls 32 extend from the central wall 31 to one side in the first direction X, are arranged at intervals in the second direction Y, and define four fitting grooves 30D to 30F aligned in the second direction Y. Two adjacent groove side walls 32 define, together with the central wall 31, one of the fitting grooves 30D to 30F. The fitting grooves 30D to 30F extend in the vertical direction Z, open upward, and open to one side in the first direction X.

The three groove side walls 33 to 35 extend from the central wall 31 to the other side in the first direction X and are arranged at intervals in the second direction Y. The groove side wall 33 is disposed on one side in the second direction Y, the groove side wall 35 is disposed on the other side in the second direction Y, and the groove side wall 34 is disposed between the groove side walls 33 and 35 on both sides in the second direction Y.

On one side in the second direction Y, the two adjacent groove side walls 33 and 34 define, together with the central wall 31, the fitting groove 30A. On the other side in the second direction Y, the two adjacent groove side walls 34 and 35 define, together with the central wall 31, the fitting groove 30B. The central groove side wall 34 defines the fitting groove 30A in a pair with the groove side wall 33, while defining the fitting groove 30B in a pair with the groove side wall 35. The fitting grooves 30A and 30B extend in the vertical direction Z, are opened upward, and are opened to the other side in the first direction X.

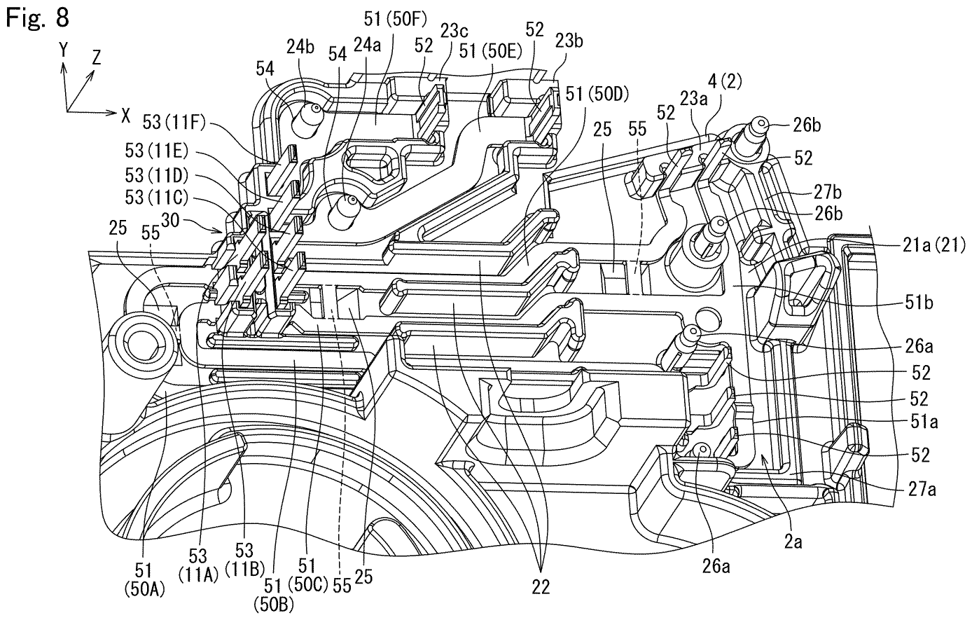

Referring to FIG. 8, the conductive plates 50A to 50F are installed on the inner surface 21a from above such that the conductive plate body 51 is housed in the corresponding guide groove. The conductive plates 50E and 50F have positioning holes 54. Pins 24a and 24b protruding upward from the inner surface 21a are inserted into the positioning holes 54. The conductive plate bodies 51 of the conductive plates 50A to 50F are arranged in alphabetical order of reference numerals from the other side to one side in the second direction Y.

The second terminals 53 of the conductive plates 50A to 50F are respectively fitted into the fitting grooves 30A to 30F of the terminal support portion 30 from above. The upper end portions (distal end portions in the terminal protruding direction) of the respective second terminals 53 protrude upward from the corresponding fitting grooves 30A to 30F to constitute the connector terminals 11A to 11F.

The six second terminals 53 are arranged in two rows aligned in the first direction X corresponding to the arrangement of the fitting grooves 30A to 30F. In the row on the other side in the first direction X, the second terminals 53 of the conductive plates 50A and 50B are arranged in the second direction Y at intervals, and the second terminal 53 of the conductive plate 50A is located on one side in the second direction Y with respect to the second terminal 53 of the conductive plate 50B. In a row on one side in the first direction X, the second terminals 53 of the conductive plates 50C to 50F are arranged at intervals from each other in alphabetical order of reference numerals from the other side to one side in the second direction Y. Each of the second terminals 53 protrudes upward from the inner surface 21a in a posture in which the plate thickness direction is oriented in the first direction X and the width direction is oriented in the second direction Y. The second terminals 53 of the conductive plates 50B and 50C are located at the other side end of each row and are arranged at the same position in the second direction Y. The second terminals 53 of the conductive plates 50A and 50D are located at the second position from the other side end of each row, and are arranged at the same position in the second direction Y.

The fitting grooves 30A and 30B are also opened to the other side in the first direction X. The conductive plate bodies 51 of the conductive plates 50A and 50B are drawn out from the fitting grooves 30A and 30B to the other side in the first direction X, folded back in a U shape, and extend toward one side in the first direction X on the other side in the second direction Y with respect to the terminal support portion 30. The fitting grooves 30C to 30F are also opened to one side in the first direction X. The conductive plate bodies 51 of the conductive plates 50C to 50F are drawn out from the fitting grooves 30C to 30F to one side in the first direction X.

The conductive plate 50C is connected to the two electric components as described above. The conductive plate 50C has a single second terminal 53, while the conductive plate body 51 is bifurcated on one end side and forms a T-shaped intersection. The conductive plate body 51 includes a first branch portion 51a extending from the T-shaped intersection to the other side in the second direction Y and a second branch portion 51b extending from the T-shaped intersection to the one side in the second direction Y. A first terminal 52 is provided at each of the distal ends of the first branch portion 51a and the second branch portion 51b.

The first terminals 52 of the conductive plates 50A and 50B and the first terminal 52 of the first branch portion 51a of the conductive plate 50C are installed on the inner surface 21a. These first terminals 52 form a row in the second direction Y. The width direction of the first terminal 52 is oriented in the second direction Y, and the plate thickness direction is oriented in the first direction X.

The conductive plate bodies 51 of the conductive plates 50A and 50B extend in a straight line in the first direction X on the other side in the second direction Y with respect to the conductive plate body 51 of the conductive plate 50C. The conductive plate bodies 51 of the conductive plates 50A and 50B terminate before the first branch portion 51a of the conductive plate 50C on one side in the first direction X and are connected to the first terminal 52. The first branch portion 51a is bent toward the other side in the first direction X at an end portion on the other side in the second direction Y (the side opposite to the T-shaped intersection), and a terminal end thereof is connected to the first terminal 52.

The first terminal 52 of the second branch portion 51b of the conductive plate 50C and the first terminal 52 of the conductive plate 50D are inserted into the pair of fitting grooves of the terminal support portion 23a from above. The fitting groove of the terminal support portion 23a is also opened to the other side in the second direction Y. The second branch portion 51b and the conductive plate body 51 of the conductive plate 50D are drawn out from the corresponding fitting groove to the other side in the second direction Y via the opening portion. The two first terminals 52 are arranged in an inclined direction slightly inclined with respect to the first direction X in a plane of the inner surface 21a, and the first terminal 52 of the conductive plate 50D is located on the other side in the first direction X with respect to the first terminal 52 of the second branch portion 51b. The width direction of the first terminal 52 is oriented in the inclination direction, and the plate thickness direction is oriented in the orthogonal direction.

The conductive plate body 51 of the conductive plate 50D is bent in an L shape before the first branch portion 51a of the conductive plate 50C on one side in the first direction X, and protrudes to one side in the second direction Y. The terminal end is connected to the root of the first terminal 52.

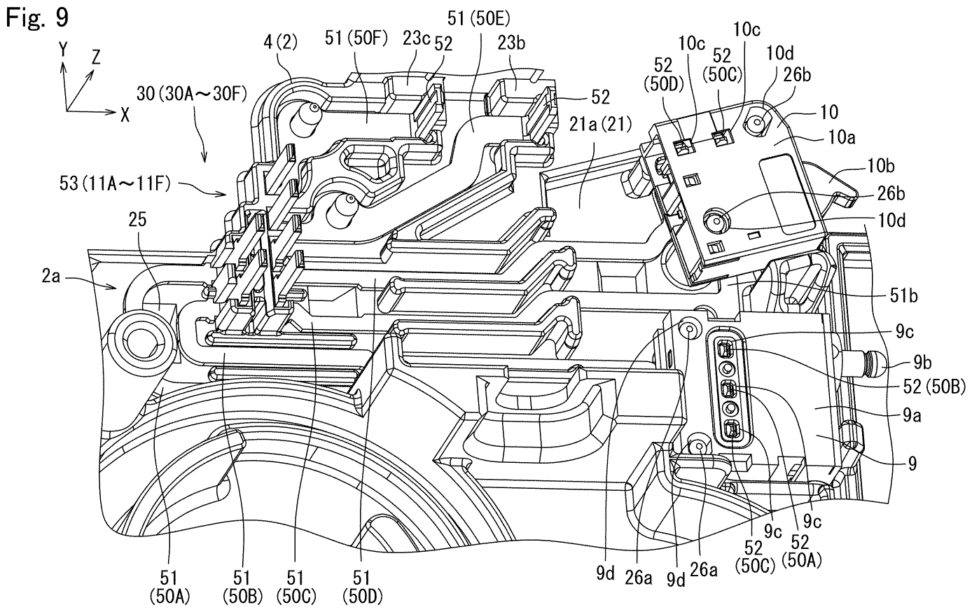

The conductive plates 50A and 50B are installed on the inner surface 21a in a state of being connected by the temporary connection portion 55. The same applies to the conductive plates 50C and 50D. Therefore, the installation work can be easily performed. The four temporary connection portions 55 are cut out using a necessary tool after the conductive plates 50A, 50B, 50C, and 50D are installed on the inner surface 21a. As a result, the conductive plates 50A and 50B are separated from each other, and the conductive plates 50C and 50D are separated from each other. When the conductive plates 50A, 50B, 50C, and 50D are properly positioned with respect to the inner surface 21a, the four temporary connection portions 55 (FIG. 9 shows three of them, the remaining one shown in FIG. 5) straddle a tool groove 25 in which the inner surface 21a is recessed downward. Since the tool can be inserted into the tool groove 25, the cutting work can be easily performed. In addition, since the temporary connection portion 55 immediately after being cut off is collected in the tool groove 25, a work of removing the cut temporary connection portion 55 from the casing 2 can also be performed simply and reliably.

The first terminal 52 of the conductive plate 50E is fitted into the fitting groove of the terminal support portion 23b from above, and the first terminal 52 of the conductive plate 50F is fitted into the fitting groove of the terminal support portion 23c from above. The fitting grooves of the terminal support portions 23b and 23c are also opened to the other side in the first direction X. The conductive plate bodies 51 of the conductive plates 50E and 50F are drawn out from the corresponding fitting grooves to the other side in the first direction X via the opening portions. The first terminals 52 of the conductive plates 50E and 50F are arranged at intervals in the first direction X. The plate thickness direction of the first terminal 52 is oriented in the first direction X, and the width direction is oriented in the second direction Y.

The first terminals 52 of the conductive plates 50E and 50F are disposed on one side in the first direction X and one side in the second direction Y with respect to the second terminals 53. The conductive plate body 51 of the conductive plate 50E extends in a direction inclined in both the first direction X and the second direction Y, and linearly connects the first terminal 52 and the second terminal 53. The conductive plate body 51 of the conductive plate 50F has an L shape including a portion extending in the first direction X and a portion extending in the second direction Y.

Referring to FIGS. 8 and 9, the two switches are then assembled.

The lock position detection switch 9 is connected to the three first terminals 52, that is, the first terminals 52 of the conductive plates 50A and 50B and the first terminal 52 of the first branch portion 51a of the conductive plate 50C. The lock position detection switch 9 includes a housing 9a, an actuator lever 9b protruding from the housing 9a, three terminal insertion holes 9c penetrating the housing 9a in the height direction, and two positioning holes 9d penetrating the housing 9a in the height direction.

In a state where the height direction of the housing 9a is oriented in the vertical direction Z, the lock position detection switch 9 is assembled to the lower case 4 downward from above (in a direction opposite to the terminal protruding direction) such that the three first terminals 52 are inserted into the three terminal insertion holes 9c and the two positioning holes 9d are fitted into the pins 26a protruding from the inner surface 21a. The bottom surface of the housing 9a abuts against the support rib 27a provided around the pin 26a and is supported in a posture parallel to the inner surface 21a. As a result, the lock position detection switch 9 is electrically connected to the three first terminals 52, and is positioned in three axial directions of the first direction X, the second direction Y, and the vertical direction Z and around the three axes with respect to the lower case 4 and the conductive plates 50A to 50C.

The half-latch detection switch 10 is connected to the two first terminals 52, that is, the first terminal 52 of the second branch portion 51b of the conductive plate 50C and the first terminal 52 of the conductive plate 50D. The half-latch detection switch 10 includes a housing 10a, an actuator lever 10b protruding from the housing 10a, two terminal insertion holes 10c penetrating the housing 10a in the height direction, and two positioning holes 10d penetrating the housing 10a in the height direction.

In a state in which the height direction of the housing 10a is oriented in the vertical direction Z, the half-latch detection switch 10 is assembled to the lower case 4 downward from above such that the two first terminals 52 are inserted into the two terminal insertion holes 10c and the two positioning holes 10d are fitted to the pins 26b protruding from the inner surface 21a. The bottom surface of the housing 10a abuts on the support rib 27b provided around the pin 26b and is supported in a posture parallel to the inner surface 21a. As a result, the half-latch detection switch 10 is connected to the two first terminals 52 and is positioned in three axial directions of the first direction X, the second direction Y, and the vertical direction Z and around the three axes with respect to the lower case 4 and the conductive plates 50C and 50D.

Returning to FIG. 5, next, the electric motor 8 is assembled.

The electric motor 8 includes an energization unit (not illustrated) exposed to the back surface of the housing. The electric motor 8 is assembled to the lower case 4 downward from above such that the first terminals 52 of the conductive plates 50E and 50F are fitted to and in contact with the energization unit with the energization unit facing downward. The housing of the electric motor 8 is supported by the upper edge of the guide rib 22 and the upper surfaces of the terminal support portions 23b and 23c. Accordingly, the electric motor 8 is positioned with respect to the lower case 4 in a state of being connected to the two first terminals 52 and being insulated from the conductive plates 50A to 50D.

Here, the dimensions of the terminal insertion holes 9c and 10c are substantially the same as the dimensions of the first terminal 52. Accordingly, while conduction between the first terminal 52 and the switch is ensured, it is necessary to push the switch against the first terminal 52 and the lower case 4. The same applies to the assembly of the electric motor 8. When a load is applied to the conductive plates 50A to 50F by this pushing, there is a possibility that the second terminal 53 is displaced on the side opposite to the first terminal 52. When the second terminal 53 is displaced, the alignment of the connector terminals 11A to 11F is disturbed, it may become impossible to assemble the upper case 3, which has through-holes corresponding to the connector terminals 11A to 11F, to the lower case 4, and there is a possibility that the work of mounting the external connector 94 becomes complicated or a connection failure with the external connector 94 occurs.

The positional deviation of the second terminal 53 is likely to occur in the following cases.
(1) A case where the width direction of the first terminal 52 and the width direction of the second terminal 53 connected thereto are parallel.
(2) A case where the conductive plate body 51 connecting the first terminal 52 and the second terminal 53 is long.
(3) A case where the conductive plate body 51 connecting the first terminal 52 and the second terminal 53 extends in a straight line.

The conductive plates 50C and 50D do not correspond to (1) and (3), and the conductive plates 50E and 50F do not correspond to (2) and (3). On the other hand, the conductive plates 50A and 50B can be said to correspond to any of (1) to (3). In the conductive plates 50C to 50F, the risk of positional deviation of the second terminal 53 is reduced.

Hereinafter, a structure for suppressing positional deviation of the second terminal 53 added to the conductive plates 50A and 50B will be described. The conductive plates 50A and 50B are an example of a “first conductive plate and a second conductive plate”, and the second terminals 53 of the conductive plates 50A and 50B are an example of a “fitted terminal”.

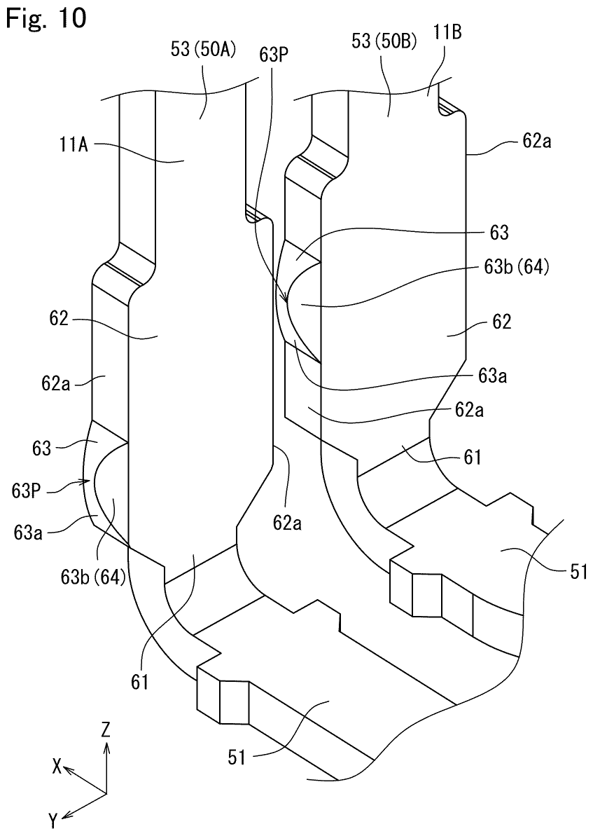

Referring to FIG. 10, the second terminal 53 of the conductive plate 50A includes a connector terminal 11A, a root portion 61, and a terminal base 62. The root portion 61 continuously rises from the conductive plate body 51. The terminal base 62 extends continuously upward from the root portion 61. The connector terminal 11A continuously protrudes upward from the terminal base 62. The terminal base 62 is wide with respect to the root portion 61 and the connector terminal 11A. A center line C53 of the root portion 61, the terminal base 62, and the connector terminal 11A in the width direction thereof forms a single straight line, and the root portion 61, the terminal base 62, and the connector terminal 11A are line-symmetric with respect to the center line C53. The terminal base 62 has a rounded rectangular shape in a front view (as viewed in the thickness direction of the second terminal 53), and has a pair of side edges 62a along the long side edge. The pair of side edges 62a are separated from each other in the width direction and extend parallel to the terminal protruding direction. The terminal base 62 is fitted into the fitting groove 30A, and the connector terminal 11A protrudes upward from the fitting groove 30A.

In addition, the second terminal 53 of the conductive plate 50A further includes a pair of fins 63. The pair of fins 63 protrude from the pair of side edges 62a to both sides in the width direction.

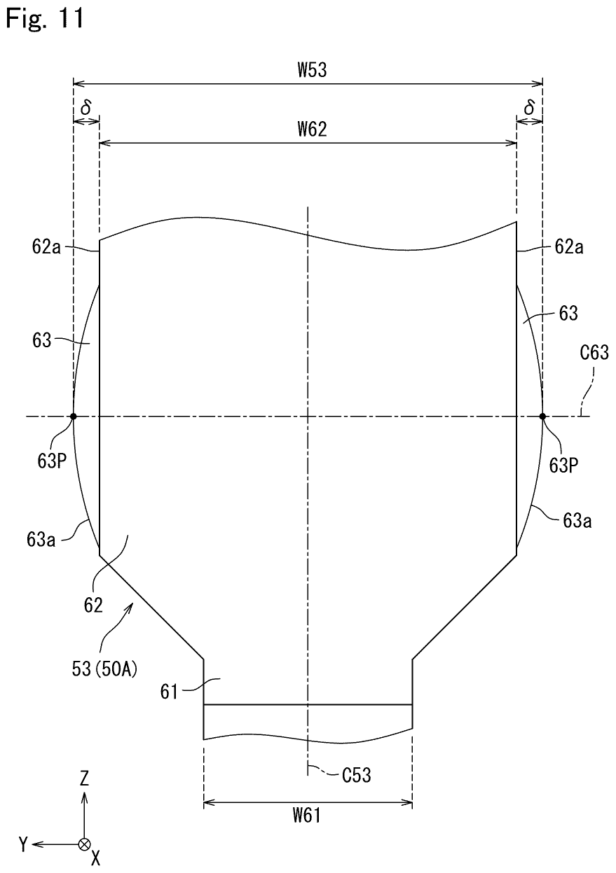

Referring to FIG. 11, the upper end and the lower end of the fin 63 are located on the side edge 62a. In front view, the contour line of the fin 63 extends outward in the width direction from the lower end of the fin 63 on the side edge 62a toward the upper side, and reaches the outermost end 63P of the fin 63. The contour line of the fin 63 extends inward in the width direction from the outermost end 63P upward, and reaches the upper end of the fin 63 on the side edge 62a.

Hereinafter, a region of the fin 63 from the lower end to the outermost end 63P is referred to as a “width gradually increasing portion 63a”. In the width gradually increasing portion 63a, the protrusion amount from the side edge 62a gradually increases from the lower end of the fin 63 toward the upper side (terminal end side in the terminal protruding direction). Hereinafter, for simplicity of description, a protrusion amount δ (the width of the fin 63 or the maximum value of the protrusion amount) at the outermost end 63P may be simply referred to as a “protrusion amount δ”.

In the present embodiment, the fin 63 is line-symmetric with respect to an imaginary line C63 passing through the outermost end 63P and extending in the width direction. The width gradually increasing portion 63a is schematically a lower half portion of the fin 63. The contour line of the fin 63 is a curve. The curve may be an arc or an elliptical arc. In order to suppress the protrusion amount of the fin 63 with respect to the height of the fin 63 (distance in the terminal protruding direction from the upper end to the lower end), the center of the arc may be located on the opposite side to the protruding direction of the fin 63 with respect to the side edge 62a.

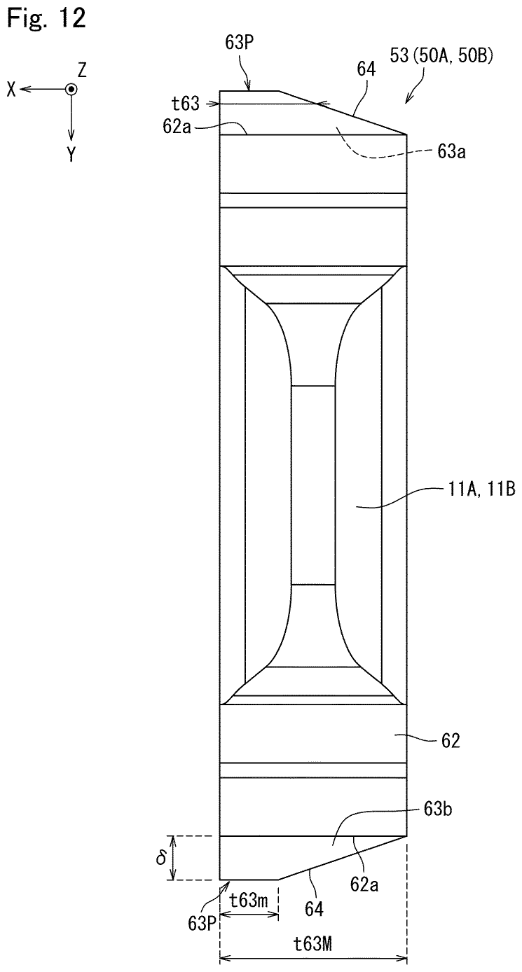

Referring to FIG. 12, the fin 63 has a plate thickness tapered portion 63b that gradually decreases the plate thickness toward the outside in the width direction. In the present embodiment, the plate thickness tapered portion 63b is set over the entire fin 63 in the width direction. A plate thickness t63 becomes the maximum plate thickness t63M at the connection portion (the innermost portion in the width direction) with the terminal base 62, and continuously decreases toward the outside in the width direction until reaching the outermost end 63P. The plate thickness t63 is a minimum plate thickness t63m at the outermost end 63P. The minimum plate thickness t63 m may be set to ½ or less and ¼ or more of the maximum plate thickness t63M.

The fin 63 has a tapered surface 64 inclined from one side to the other side in the plate thickness direction toward the outside in the width direction. The tapered surface 64 is a flat surface extending linearly in a plan view (as viewed in the terminal protruding direction). The tapered surface 64 forms an angle with the end surface of the terminal base 62 on one side in the plate thickness direction. The tapered surface 64 terminates on one side in the plate thickness direction with respect to the other end surface of the terminal base 62 on the other side in the plate thickness direction, whereby the thickness remains small even at the outermost end 63P.

Referring to FIGS. 11 and 12, the pair of fins 63 are line-symmetric with respect to the center line C53. Here, the width of the root portion 61 is referred to as “root width W61”, the distance in the width direction between the pair of side edges 62a of the terminal base 62 is referred to as “terminal base width W62”, and the distance in the width direction between the outermost ends 63P of the pair of fins 63 is referred to as a “terminal full width W53”. The width of the conductive plate body 51 is equal to the root width W61.

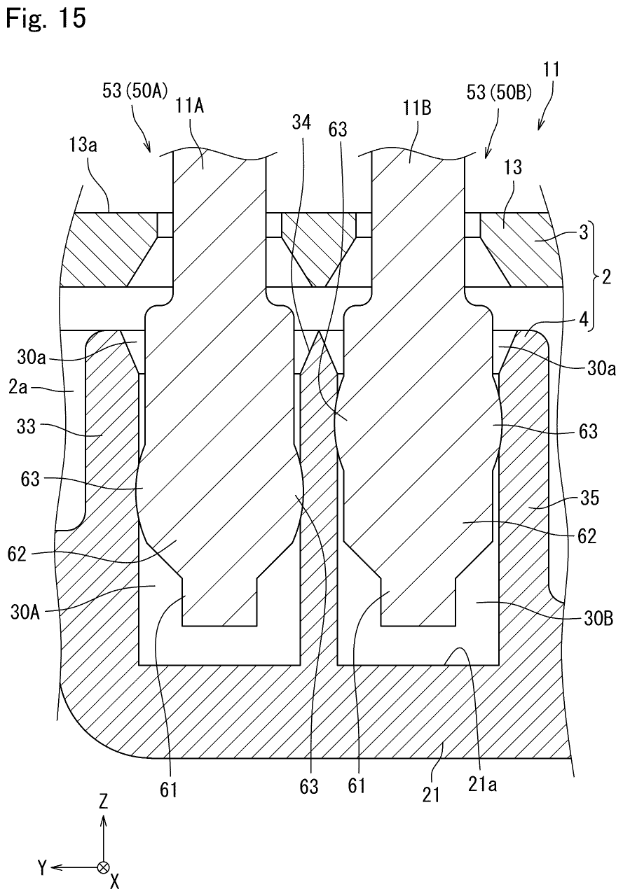

Although the second terminal 53 of the conductive plate 50A has been described so far, the second terminal 53 of the conductive plate 50B is also configured in the same manner as described above. Referring to FIGS. 10 and 15, the second terminals 53 of the conductive plates 50A and 50B are adjacent to each other in the width direction. The fin of the conductive plate 50A and the fin of the conductive plate 50B are shifted in the terminal protruding direction. Merely by way of example, in the present embodiment, the fin 63 of the conductive plate 50A is located below and the fin of the conductive plate 50B is located above.

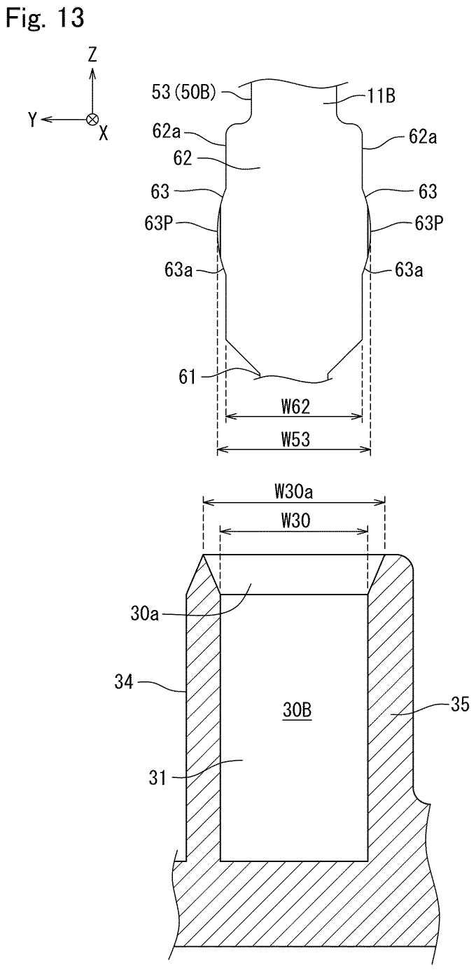

With reference to FIGS. 13 to 15, the pair of groove side walls 33 and 34 of the terminal support portion 30 define a fitting groove 30A into which the second terminal 53 of the conductive plate 50A is fitted, and the pair of groove side walls 34 and 35 of the terminal support portion 30 define a fitting groove 30B into which the second terminal 53 of the conductive plate 50B is fitted. Hereinafter, for convenience of description, an opposing direction of a pair of groove side walls defining the fitting grooves 30A and 30B is referred to as a “width direction” in accordance with the second terminal 53.

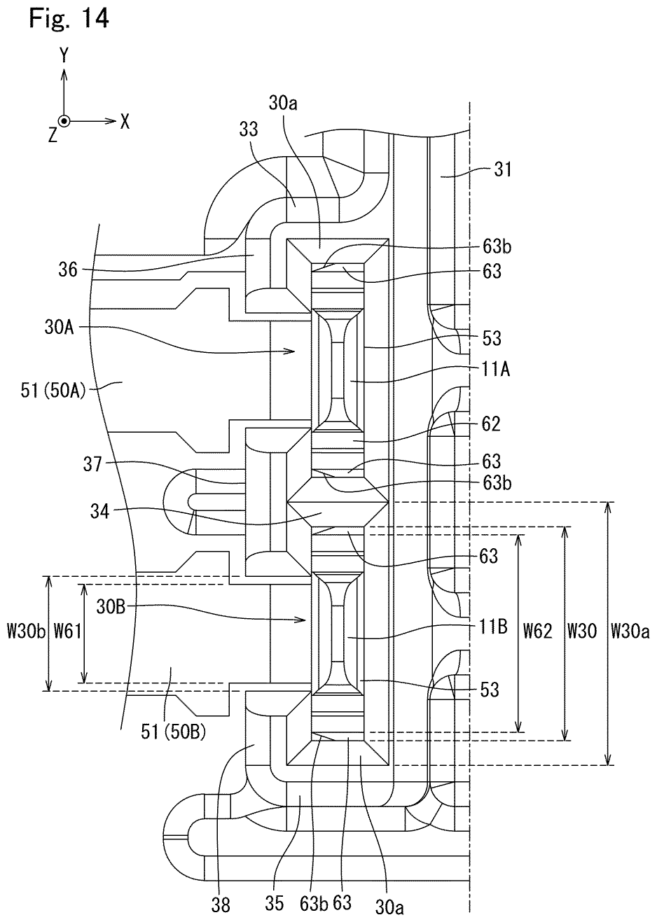

Referring to FIGS. 14 and 15, the pair of groove side walls 33 and 34 have enlarged portions 30a inclined outward in the width direction toward the upper side (terminal end side in the terminal protruding direction) at the upper end portions thereof. Similarly, the pair of groove side walls 34 and 35 are also provided with enlarged portions 30a (see also FIG. 13). As a result, the upper openings of the fitting grooves 30A and 30B expand in the width direction.

Referring to FIGS. 4 and 14, the terminal support portion 30 has three engagement walls 36 to 38. The three engagement walls 36 to 38 are continuous with respective end edges of the three groove side walls 33 to 35 and extend in the second direction Y and the vertical direction Z. The engagement wall 36 protrudes from an end edge of the groove side wall 33 to the other side in the second direction Y. The engagement wall 37 protrudes from an end edge of the groove side wall 34 to both sides in the second direction Y. The engagement wall 38 protrudes to one side in the second direction Y from an end edge of the groove side wall 35. The fitting groove 30A is also opened to the side (the other side in the first direction X), and the lateral opening is narrowed by the engagement walls 36 and 37. Similarly, the lateral opening of the fitting groove 30B is narrowed by the engagement walls 37 and 38.

Here, the distance in the width direction between the inner surfaces of the pair of groove side walls 34 and 35 is referred to as a “groove width W30”. The width of the upper end opening of each of the fitting grooves 30A and 30B defined by the enlarged portion 30a is defined as an “upper opening width W30a”. The width of the lateral opening of each of the fitting grooves 30A and 30B defined by the engagement wall is referred to as a “lateral opening width W30b”.

The lateral opening width W30b is larger than the root width W61 and smaller than the terminal base width W62. The groove width W30 is larger than the terminal base width W62. The terminal full width W53 is larger than the groove width W30 in a state where the second terminals 53 are removed from the fitting grooves 30A and 30B. The opening width W30a is larger than the terminal full width W53.

Referring to FIGS. 4, 8, and 13 to 15, the second terminals 53 of the conductive plates 50A and 50B are simultaneously fitted into the fitting grooves 30A and 30B in a state of being connected to each other by the temporary connection portions 55. The second terminal 53 is sequentially inserted into the fitting groove 30A and 30B from the root portion such that the conductive plate body 51 is drawn out from the lateral opening.

Although the fin 63 of the conductive plate 50A can pass through the upper opening, the width gradually increasing portion 63a abuts on the surface of the enlarged portion 30a. Thereafter, when the second terminal 53 is pushed downward, a force for widening outward in the width direction acts on the groove side walls 33 and 34 by the action of the inclination of the contour line of the width gradually increasing portion 63a and the surface inclination of the enlarged portion 30a. Therefore, the second terminal 53 can move downward while receiving reaction force from the groove side walls 33 and 34.

When the fin 63 passes through the enlarged portion 30a, the outermost end 63P comes into pressure contact with the groove side walls 33 and 34. The pair of fins 63 apply substantially equal pressure contact force to the groove side walls 33 and 34. Therefore, the center of the fitting groove 30A in the width direction coincides with the center line C53 of the second terminal 53. When the conductive plate body 51 reaches the inner surface 21a, the insertion of the conductive plate 50A into the fitting groove 30A is stopped.

While the conductive plate 50A moves downward while receiving reaction force from the groove side walls 33 and 34, the fin 63 abuts on the enlarged portion 30a also in the case of the conductive plate 50B. Thereafter, also in the conductive plate 50B, in the same manner as described above, the second terminal 53 moves downward while receiving reaction force from the groove side walls 34 and 35 until the conductive plate body 51 reaches the inner surface 21a.

As described above, in the door latching device 1 according to the present embodiment, the second terminal 53 of the conductive plate 50A includes the terminal base 62 having the pair of side edges 62a separated from each other in the width direction and extending in the terminal protruding direction, and the fins 63 protruding in the width direction from the side edges 62a and coming into pressure contact with the groove side walls 33 and 34 in the fitting groove 30A. Similarly, the second terminal 53 of the conductive plate 50B also includes a fin 63 that comes into pressure contact with the groove side walls 34 and 35 in the fitting groove 30B.

Therefore, even if a load is applied to the conductive plates 50A and 50B when the lock position detection switch 9 as an electric component is attached to each of the first terminals 52 of the conductive plates 50A and 50B, displacement of the second terminal 53 can be suppressed by friction between the fin 63 and the groove side walls 33 to 35. Since the alignment arrangement of the connector terminals 11A to 11F can be realized, workability of assembling the upper case 3 to the lower case 4 is improved, and defective assembly between the upper case 3 and the lower case 4 can be prevented. Furthermore, when the upper case 3 does not include through-holes (alignment holding means) for individually inserting the connector terminals 11A to 11F, workability of mounting the external connector 94 on the connector 11 is improved, and a connection failure between the external connector 94 and the connector 11 can be prevented.

In the conductive plates 50A and 50B, the width direction of the first terminal 52 is parallel to the width direction of the second terminal 53. In addition, the conductive plate body 51 is relatively long and extends in a straight line in the first direction X. Since the above-described structure is applied to the second terminals 53 of the conductive plates 50A and 50B, the risk of positional deviation of the second terminals 53 can be effectively reduced.

The terminal full width W53 is larger than the groove width W30 in a state where the second terminals 53 are removed from the fitting grooves 30A and 30B. Therefore, the fins 63 are inserted into the fitting grooves 30A and 30B in an interference fit manner. As a result, a structure that exerts a pressure contact force is realized.

The terminal base width W62 is smaller than the groove width W30. The terminal base 62 is inserted into the fitting grooves 30A and 30B in a form of gap fitting. Since the interference fitting is performed only at the portion where the fin 63 is provided, the pushing force required for the work of inserting the second terminals 53 into the fitting grooves 30A and 30B can be reduced.

The fin 63 has a plate thickness tapered portion 63b. The plate thickness is minimized at the outermost end 63P that is brought into pressure contact with the groove side wall, and the pressure contact area is reduced. Therefore, the pushing force required for the work of inserting the second terminals 53 into the fitting grooves 30A and 30B can be reduced.

The fin 63 has a width gradually increasing portion 63a that gradually increases the protrusion amount from the side edge 62a from the lower end toward the terminal end side in the terminal protruding direction. As a result, the groove side wall can be expanded by the effect of the slope, and the insertion work is facilitated.

In an aspect in which the conductive plates 50A and 50B are adjacent in the width direction, the groove side wall 34 defines the fitting groove 30A of the conductive plate 50A and defines the fitting groove 30B of the conductive plate 50B. By sharing the groove side wall 34, the second terminals 53 of the conductive plates 50A and 50B can be brought close to each other in the width direction, and the connector terminals 11A to 11F can be densely arranged.

The fin 63 of the conductive plate 50A and the fin 63 of the conductive plate 50B are shifted in the terminal protruding direction. As compared with the case where the fins 63 are at the same position in the terminal protruding direction, the conductive plate 50A and the conductive plate 50B can be arranged close to each other in the width direction, and it is also possible to secure a deflection allowance for the shared groove side wall 34 caused by press-fitting of the fins 63. This contributes to the dense arrangement of the connector terminals 11A to 11F.

The above configuration can be appropriately changed within the scope of the present invention.

The second terminals 53 of the conductive plates 50C to 50F may also be configured similarly to the second terminals 53 of the conductive plates 50A and 50B according to the above embodiment. The first terminals 52 of the conductive plates 50C to 50F are supported by the terminal support portions 23a to 23c. The first terminal 52 and the terminal support portions 23a to 23c may be configured in the same manner as in the above embodiment. The first terminals 52 of the conductive plates 50A to 50C may be supported by the terminal support portion. In this case, the first terminal 52 and the terminal support portion may be configured in the same manner as in the above embodiment. As described above, the fitted terminal having the fin 63 may be the first terminal 52 or the second terminal 53.

What is claimed is:

1. A vehicle door latching device, comprising:
a casing attached to a vehicle;
a latch mechanism that is provided in the casing and switches between a latched state in which a door of the vehicle is held in a closed state and an unlatched state in which opening of the door is allowed;
a lock mechanism that is displaced between an unlock position in which switching of the latch mechanism to the unlatched state is allowed and a lock position in which switching of the latch mechanism to the unlatched state is disabled;
an electrical component associated with operation of the latch mechanism or the lock mechanism;
a conductive plate housed in the casing, the conductive plate including:
a conductive plate body extending along an inner surface of the casing,
a first terminal provided at one end portion of the conductive plate body, protruding in a terminal protruding direction perpendicular to an extending direction of the conductive plate body, and connected to the electrical component, and
a second terminal provided at the other end portion of the conductive plate body, protruding in the terminal protruding direction, and being connectable to an external component provided in the vehicle; and
a terminal support portion having a pair of groove side walls protruding from the inner surface of the casing and facing each other in a width direction, and defining a fitting groove in which the first terminal or the second terminal is fitted between the pair of groove side walls, wherein
a fitted terminal of the first terminal and the second terminal to be fitted into the fitting groove includes:
a terminal base including a pair of side edges separated from each other in the width direction and extending in the terminal protruding direction, and
a fin protruding from the side edge in the width direction and coming into pressure contact with the groove side wall in the fitting groove.

2. The vehicle door latching device according to claim 1, wherein
the electrical component has a terminal connection hole into which the first terminal is pushed, and
the second terminal is the fitted terminal.

3. The vehicle door latching device according to claim 2, wherein the second terminal constitutes a connector terminal of a connector mechanically and electrically connected to an external connector provided in the vehicle.

4. The vehicle door latching device according to claim 1, wherein
the conductive plate includes a first conductive plate and a second conductive plate adjacent to each other,
the first terminal of the first conductive plate and the first terminal of the second conductive plate are connected to the same electrical component, and
the terminal support portion defines, as the fitting groove, a first fitting groove into which the fitted terminal of the first conductive plate is fitted and a second fitting groove into which the fitted terminal of the second conductive plate is fitted.

5. The vehicle door latching device according to claim 4, wherein
the first fitting groove and the second fitting groove are arranged in the width direction, and
the fin of the first conductive plate and the fin of the second conductive plate are shifted in the terminal protruding direction.

6. The vehicle door latching device according to claim 1, wherein the fins protrude from the pair of side edges to both sides in the width direction.

7. The vehicle door latching device according to claim 6, wherein in a state where the second terminal is removed from the fitting groove, a terminal full width that is a distance in the width direction between outermost ends of the fins is larger than a groove width that is a distance between inner surfaces of the pair of groove side walls.

8. The vehicle door latching device according to claim 1, wherein the fin includes a plate thickness tapered portion that gradually decreases the plate thickness toward the outside in the width direction.

9. The vehicle door latching device according to claim 1, wherein the fin includes a width gradually increasing portion that gradually increases a protruding amount from the side edge from a lower end of the fin toward a terminal end side in the terminal protruding direction.

10. The vehicle door latching device according to claim 2, wherein
the conductive plate includes a first conductive plate and a second conductive plate adjacent to each other,
the first terminal of the first conductive plate and the first terminal of the second conductive plate are connected to the same electrical component, and
the terminal support portion defines, as the fitting groove, a first fitting groove into which the fitted terminal of the first conductive plate is fitted and a second fitting groove into which the fitted terminal of the second conductive plate is fitted.

11. The vehicle door latching device according to claim 3, wherein
the conductive plate includes a first conductive plate and a second conductive plate adjacent to each other,
the first terminal of the first conductive plate and the first terminal of the second conductive plate are connected to the same electrical component, and
the terminal support portion defines, as the fitting groove, a first fitting groove into which the fitted terminal of the first conductive plate is fitted and a second fitting groove into which the fitted terminal of the second conductive plate is fitted.

12. The vehicle door latching device according to claim 2, wherein the fins protrude from the pair of side edges to both sides in the width direction.

13. The vehicle door latching device according to claim 3, wherein the fins protrude from the pair of side edges to both sides in the width direction.

14. The vehicle door latching device according to claim 2, wherein the fin includes a plate thickness tapered portion that gradually decreases the plate thickness toward the outside in the width direction.

15. The vehicle door latching device according to claim 3, wherein the fin includes a plate thickness tapered portion that gradually decreases the plate thickness toward the outside in the width direction.

16. The vehicle door latching device according to claim 2, wherein the fin includes a width gradually increasing portion that gradually increases a protruding amount from the side edge from a lower end of the fin toward a terminal end side in the terminal protruding direction.

17. The vehicle door latching device according to claim 3, wherein the fin includes a width gradually increasing portion that gradually increases a protruding amount from the side edge from a lower end of the fin toward a terminal end side in the terminal protruding direction.
